(19) United States
(12) Patent Application Publication
(10) Pub. No.: US 2023/0248032 A1
(43) Pub. Date: Aug. 10, 2023

(54) WHOLE SOY FOODSTUFF AND METHODS OF MAKING THE SAME

(71) Applicant: The Coca-Cola Company, Atlanta, GA (US)

(72) Inventors: Rohan DODAL, Atlanta, GA (US); Mamunur RAHMAN, Atlanta, GA (US)

(73) Assignee: The Coca-Cola Company, Atlanta, GA (US)

(21) Appl. No.: 18/003,280

(22) PCT Filed: Jun. 25, 2021
(86) PCT No.: PCT/US2021/039116

§ 371 Date: Dec. 23, 2022

Related U.S. Application Data
(60) Provisional application No. 63/044,804, filed on Jun. 26, 2020.

(51) Int. Cl. A23L 11/00; A23L 11/65; A23C 11/10

(52) U.S. Cl. CPC A23L 11/07; A23L 11/65; A23C 11/103

(57) ABSTRACT

The present disclosure provides a process to make whole soy foodstuff or beverage without removing soy pulp or okara during the process. The process includes liquefying whole soybeans, forming a liquefaction product, wherein the liquefaction product comprises a liquid fraction and a soy pulp fraction; and treating the liquefaction product with an enzyme, thereby forming a whole soy base. The whole soy base can itself serve as a soy beverage, or alternatively combined with other ingredients or subjected to further treatment to make final soy foodstuff or beverages.

This application is being filed on Jun. 25, 2021, as a PCT International Patent application and claims the benefit of and priority to U.S. Provisional patent application Ser. No. 63/044,804, filed Jun. 26, 2020, the entire disclosure of which is incorporated by reference in its entirety.

### INTRODUCTION

Soybean or legume based food products are known for their high nutritional value and other health benefits such as the reduction of blood cholesterol and incidents of osteoporosis. However, the manufacture of soy beverages and food products presents a variety of problems due to the nature of soybeans. For example, typical whole soy beverages usually have a thick, chalky, or gritty mouthfeel due to the complex carbohydrates and/or fibrous texture present in the soybean cotyledons and hulls. Further, soy beverages are typically plagued with excessive “beany” taste resulted from the undegraded cell tissue of soybean cotyledons and/or cotyledons that are disrupted in the presence of moisture and oxygen.

In conventional soy beverage manufacturing processes, some efforts have been made to address these problems. For example, typical soymilk beverages include a combination of water and soymilk concentrate produced from a process whereby whole soybeans are dehulled and blanched. To reduce the chalky texture of the soy beverage, soybeans are dehulled prior to or during processing. Alternatively, the thick texture may be reduced by liquefying and/or extracting the soybeans. Conventional liquefaction or extraction includes crushing/grinding/milling the whole soybeans in water and pressing the resultant slurry to squeeze out a soybean liquid. The slurry containing a soybean liquid and insoluble or non-dispersible soy pulp (also called okara) are of high viscosity in nature, and is often not directly consumable. Usually, the soy pulp or okara is not further treated, but is discarded or removed for other use such as animal feed, which considerably impacts the economic efficiency of soybeans consumption by human. In addition, elimination of soy pulp from the soy beverage may significantly impair the nutrition value and the natural “soy” flavor due to the significant reduction or elimination of fiber and protein contents.

In addition, the removal of soy pulp in the beverage making process and the removal of the resultant thick texture from the beverage product may raise another problem during storage of the beverage in containers. In particular, the beverage, free from soy pulp, may be extremely unsuitable for human consumption. The beverage can separate into immiscible layers such as a clumpy colloidal (particle) phase at the base of the container, and a whey water phase at the top of the container. Accordingly, the beverage becomes unattractive in this separated, clumpy-looking state. Consumers must vigorously shake the container to recombine the colloidal phase and water phase before consuming the beverage to avoid an unpleasant texture.

Various methods are disclosed to make beverages with new characteristics and/or increased stability. For example, WO 02/11557 to Nsofor describes a process for producing a stabilized soy beverage from dehulled-whole soybeans partially hydrolyzed with enzymes. The process includes hydrating the soybeans to activate endogenous enzymes within the soybeans; dehulling the soybeans; and hydrolyzing the proteins within the dehulled soybean cotyledons by incubating the cotyledons at elevated temperatures.

WO 2013/173869 to Hodgkinson relates to a cereal-based beverage composition, which includes (i) at least one cereal grain in finely divided form, dispersed within (ii) a beverage liquid; the composition being suitable for human consumption, and wherein the grain of (i) has been enzymatically digested to render the grain constituents able to be suspended in solution.

WO 01/24644 to Gandhi relates to a process for preparing a soy milk that mimics diary milk with respect to mouthfeel. The method includes (1) providing a dry ground soybean particulate, (2) incorporating either an organic or inorganic acid or an acid salt thereof, (3) adding water in an amount sufficient to provide a liquid consistency, and (4) treating the liquid at a pressure greater than about 2,000 psi.

WO 2012/076565 to Valdez relates to a beverage comprising a flavor component, a hydrolyzed whole grain composition, an alpha-amylase or fragments thereof, which alpha-amylase or fragments thereof show no hydrolytic activity towards dietary fibers when in the active state, a sucrose content below 5% by weight of the beverage, and wherein the beverage has a viscosity in the range 1-300 mPa·s.

In spite of the above disclosures, it is still challenging to make soy foodstuff or soy beverages meeting all the consumer needs stated herein in a single product. There are still a considerable number of problems and deficiencies associated with existing soy beverages. There is a demonstrated need for a tasteful, satisfying drink product and method of preparation, in order to better utilize the health and nutritional benefits associated with soy foodstuffs. The present disclosure provides processes of manufacturing whole soy products that may include many or all of the aforementioned consumer needs in a single soy beverage.

### Whole Soy Foodstuff and Methods of Making the Same

### Summary of Disclosure

The present disclosure generally relates to a process to make whole soy food products. The present process combines mechanical liquefaction with enzyme treatment to produce soy foodstuff and beverages that have optimized viscosity and texture, natural “soy” flavor, enhanced nutritional value, balanced calorie, and prolonged storage stability. In particular, the present process involves maximal use of whole soybeans, dispensing the need to remove the hull or soy pulp before or during the liquefaction process, thereby significantly saving the manufacturing time and cost, and improving the economic efficiency of soy consumption by human. The present process also involves treating the intermediate soy products generated from the process with an enzyme, which efficiently and effectively optimizes the viscosity, texture, taste and nutritional profiles. The whole soy food products made from the present process may be used to produce dairy/soy-based products, soy-based beverages and to nutritionally fortify a variety of foods.

Notably, because the whole soy beverage of the present disclosure is created from whole soybeans without removing hulls or soy pulp, most of the beneficial nutrients of the whole soybeans, such as soy proteins, fibers, isoflavones, omega-3-fatty acids and vitamin E, to name a few, are present in the resultant soy food products. Compared with the soy beverage made by the conventional process which removes or eliminates the hulls or soy pulp (okara), the present soy beverage has higher fibrous content, enhanced nutritional value, and a balanced “beany” taste with natural “soy” flavor.

The resultant soy-based products exhibit stability for extended periods of storage and remain a natural “soy” flavor with reduced “chalky” or “thick” texture. During storage, the colloidal and water phases of the whole soy products made from the present process do not separate, even for extended periods of storage.

In some aspects, the present disclosure relates to a process of making a whole soy food product (or a whole soy base) comprising, liquefying whole soybeans, forming a liquefaction product, wherein the liquefaction product comprises a liquid fraction and a soy pulp fraction; and treating the liquefaction product with an enzyme, thereby forming the whole soy food product. In embodiments, the whole soy food product made from the present process has a viscosity from about 10 centipoises to about 100 centipoises, or from about 20 centipoises to about 80 centipoises, or from about 30 centipoises to about 70 centipoises, or from about 40 centipoises to about 60 centipoises.

In embodiments, the weight ratio of the liquid fraction to the soy pulp fraction of the liquefaction product according to the present process is in a range from about 99:1 to about 1:99, or from about 90:10 to about 10:90, or from about 80:20 to about 20:80, or from about 70:30 to about 30:70, or from about 60:40 to about 40:60. In embodiments, the liquefaction product of the present process has an average particle size in a range from about 30 micrometers to about 100 micrometers, or from about 40 micrometers to about 90 micrometers, or from about 50 micrometers to about 80 micrometers, or from about 60 micrometers to about 70 micrometers. In embodiments, the liquefaction product of the present process has an average viscosity from about 100 centipoises to about 500 centipoises, or from about 150 centipoises to about 400 centipoises or from about 200 centipoises to about 400 centipoises, or from about 250 centipoises to about 300 centipoises. In embodiments, the liquefaction product of the present process has an average fiber content from about 0.5 wt % to about 5 wt %, or from about 0.7 wt % to about 4 wt %, or from about 0.9 wt % to about 3 wt %, or from about 0.9 wt % to about 2 wt %, or from about 0.9 wt % to about 1.3 wt %. In embodiments, the liquefaction product of the present process has a solid content from about 5 wt % to about 50 wt %, or from about 10 wt % to about 40 wt %, or from about 15 wt % to about 30 wt %, or from about 20 wt % to about 25 wt %.

In some embodiments, liquefying whole soybeans of the present process is performed using a method selected from the group consisting of grinding, milling, colloidal milling, knife grinding, or combinations thereof. In embodiments, the enzyme of the present process is selected from the group consisting of amylases, protease, cellulase, or combinations thereof. Non-limiting examples of amylases include alpha-amylase, fungal alpha-amylase, and gluco-amylase. In embodiments, the enzyme of the present process reduces the viscosity of the liquefaction product by at least 20%, or at least 30%, or at least 40%, or at least 50%, or at least 60%, or at least 70%, or at least 80%, or at least 90%, or at least 95%, or at least 99%.

In embodiments, the whole soy food product made by the present process has an average particle size from about 30 micrometers to about 100 micrometers, or from about 40 micrometers to about 90 micrometers, or from about 50 micrometers to about 80 micrometers, or from about 60 micrometers to about 70 micrometers. In embodiments, the whole soy food product made by the present process has a Brix value from about 5° to about 25°, or from about 6° to about 22°, or from about 7° to about 20°, or from about 8° to about 16°, or from about 100 to about 14°, from about 110 to about 13°. In embodiments, the whole soy food product made by the present process has a solid content from about 5 wt % to about 30 wt %, or from about 10 wt % to about 20 wt %, or from about 10 wt % to about 20 wt %, or from about 10 wt % to about 15 wt %.

In embodiments, the whole soy food product (or whole soy base) made by the present process is suitable for consumption for at least 12 months. In embodiments, the whole soy base does not show obvious separation of fat, sedimentation, precipitation, or coagulation for at least 12 months.

In some aspects, the present disclosure relates to a soy foodstuff comprising at least a portion of a whole soy product (or a whole soy base) made by the process according to the present disclosure. In embodiments, the process comprises: liquefying whole soybeans, forming a liquefaction product, wherein the liquefaction product comprises a liquid fraction and a soy pulp fraction; and treating the liquefaction product with an enzyme, thereby forming the whole soy food product.

In some aspects, the present disclosure relates to a soy beverage comprising at least a portion of a whole soy product (or a whole soy base) made by the process according to the present disclosure. In embodiments, the process comprises: liquefying whole soybeans, forming a liquefaction product, wherein the liquefaction product comprises a liquid fraction and a soy pulp fraction; and treating the liquefaction product with an enzyme, thereby forming the whole soy food product. In embodiments, the soy beverage has a viscosity from about 10 centipoises to about 100 centipoises, or from about 20 centipoises to about 80 centipoises, or from about 30 centipoises to about 70 centipoises, or from about 40 centipoises to about 60 centipoises. In embodiments, soy beverage has an average particle size from about 30 micrometers to about 100 micrometers, or from about 40 micrometers to about 90 micrometers, or from about 50 micrometers to about 80 micrometers, or from about 60 micrometers to about 70 micrometers. In embodiments, the soy beverage has a Brix value from about 5° to about 25°, or from about 6° to about 22°, or from about 7° to about 20°, or from about 8° to about 18°, or from about 8° to about 16°, or from about 100 to about 14°, from about 110 to about 13°. In embodiments, the soy beverage has a solid content from about 5 wt % to about 30 wt %, or from about 10 wt % to about 25 wt %, or from about 10 wt % to about 20 wt %, or from about 10 wt % to about 15 wt %.

### Definitions and Interpretations of Terms

As used herein, “weight percent,” “wt %, “percent by weight,” “% by weight,” and variations thereof refer to the concentration of a substance as the weight of that substance divided by the total weight of the composition and multiplied by 100. It is understood that, as used here, “percent,” “%,” and the like are intended to be synonymous with “weight percent,” “wt %, etc.

As used herein, “g” represents gram; “L” represents liter; “mg” represents “milligram (10⁻³ gram);” “mL” represents milliliter (10⁻³ liter); “nm” represents nanometer (10⁻⁹ meter); micrometer is 10⁻⁶ meter. The units “mg/100 g,” “mg/100 mL,” or “mg/L” are units of concentration or content of a component in a composition. One “mg/L” equals to one ppm (part per million). “Da” refers to Dalton, which is the unit for molecular weight; One Da equals to one g/mol. The unit of temperature used herein is degree Celsius (° C.).

The term “about” is used in conjunction with numeric values to include normal variations in measurements as expected by persons skilled in the art, and is understood to have the same meaning as “approximately” and to cover a typical margin of error, such as +15% of the stated value. The term “about” also encompasses amounts that differ due to different equilibrium conditions for a composition resulting from a particular initial composition. Whether or not modified by the term “about,” the claims include equivalents to the quantities.

It should be noted that, as used in this specification and the appended claims, the singular forms “a,” “an,” and “the” include plural referents unless the content clearly dictates otherwise. Thus, for example, reference to a composition containing “a compound” includes having two or more compounds that are either the same or different from each other. It should also be noted that the term “or” is generally employed in its sense including “and/or” unless the content clearly dictates otherwise.

In the interest of brevity and conciseness, any ranges of values set forth in this specification contemplate all values within the range and are to be construed as support for claims reciting any sub-ranges having endpoints which are real number values within the specified range in question. By way of a hypothetical illustrative example, a disclosure in this specification of a range of from 1 to 5 shall be considered to support claims to any of the following ranges: 1-5; 1-4; 1-3; 1-2; 2-5; 2-4; 2-3; 3-5; 3-4; and 4-5.

The term “substantially free” may refer to any component that the composition of the disclosure lacks or mostly lacks. When referring to “substantially free” it is intended that the component is not intentionally added to compositions of the disclosure. Use of the term “substantially free” of a component allows for trace amounts of that component to be included in compositions of the disclosure because they are present in another component. However, it is recognized that only trace or de minimus amounts of a component will be allowed when the composition is said to be “substantially free” of that component. Moreover, the term if a composition is said to be “substantially free” of a component, if the component is present in trace or de minimus amounts it is understood that it will not affect the effectiveness of the composition. It is understood that if an ingredient is not expressly included herein or its possible inclusion is not stated herein, the disclosure composition may be substantially free of that ingredient. Likewise, the express inclusion of an ingredient allows for its express exclusion thereby allowing a composition to be substantially free of that expressly stated ingredient.

As used herein, “whole soybeans” are any known variety of soybeans with the hull intact. A whole soybeans generally include an exterior shell, or “hull” that encapsulates the inner portion of the soybean, or the “cotyledon.” The cotyledon is comprised of a variety of different proteins including mono-, di-, and polypeptides, and sugars, including mono-, di-, and polysaccharides. The cotyledon may also include “endogenous enzymes,” which are those enzymes that metabolize proteins and sugars of the cotyledon to promote germination and growth of the soybean plant. Endogenous enzymes of whole soybeans generally do not include amylase or analogues thereof. Other components and chemicals present in the cotyledon include isoflavones, goitrogens, phytestrogens, Bowman-Birk trypsin inhibitors, saponins, phytates, phosphatides, fiber, fatty acids, vitamins, and minerals.

As used herein, suitability for human consumption means a foodstuff that is officially edible by human without changes in quality due to deterioration, decomposition, or contamination.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the disclosure. In the following description, various embodiments of the present disclosure are described with reference to the following drawings, in which:

FIG. 1 shows a block diagram of a general process according to the present disclosure.

FIG. 2 shows a block diagram of a specific embodiment of a process according to the present disclosure.

FIG. 3 shows a block diagram of another specific embodiment of a process according to the present disclosure.

### DETAILED DESCRIPTION

The present disclosure generally relates to a process of making or manufacturing a whole soy food product (or a whole soy base) from whole soybeans. The whole soy base may itself serve as a final soy product or otherwise may be combined with other ingredients to form a final soy foodstuff or soy beverage. The whole soy base according to the present disclosure is an aqueous preparation of whole soybean without removal of soy hull or soy pulps during the process of manufacturing. The present whole soy base exhibits: (a) stability of liquid whole soy base without separation of fat, sedimentation, or coagulation; (b) optimized viscosity, reduced “chalky” texture or “thick” mouthfeel, and natural “beany” flavor; (c) prolonged storage life; (d) improved nutritional value and balanced calorie; (e) increased economic efficiency of soybean consumption by human.

In some aspects, the present disclosure relates to a process of making a whole soy food product (or a whole soy base) comprising, liquefying whole soybeans, forming a liquefaction product, wherein the liquefaction product comprises a liquid fraction and a soy pulp fraction; and treating the liquefaction product with an enzyme, thereby forming the whole soy food product. In embodiments, the whole soy food product made from the present process has a viscosity from about 10 centipoises to about 100 centipoises, or from about 20 centipoises to about 80 centipoises, or from about 30 centipoises to about 70 centipoises, or from about 40 centipoises to about 60 centipoises.

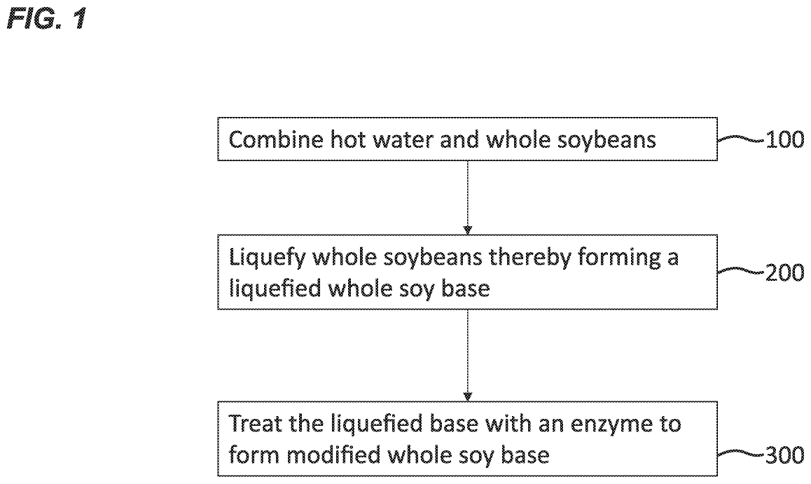

FIG. 1 shows a diagram of the general process of producing a whole soy food product according to the present disclosure. The process comprises step 100 of combining hot water and whole soybeans, step 200 of liquefying whole soybeans thereby forming a liquefaction product, and step 300 of treating the liquefaction product with an enzyme thereby forming the whole soy food product (or a whole soy base).

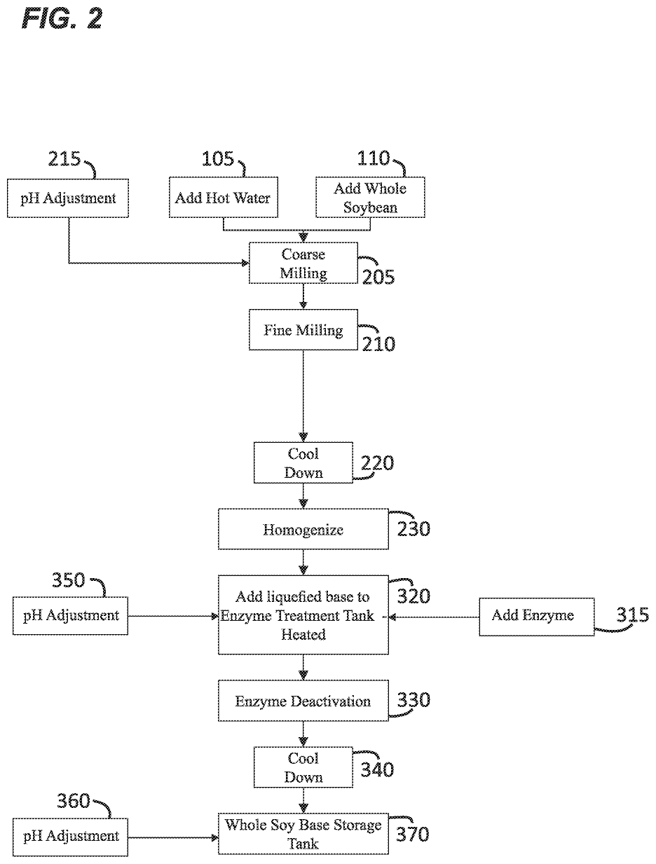

FIG. 2 shows a block diagram of a specific embodiment of a process according to the present disclosure. The process comprises forming a mixture by adding hot water 105 and adding whole soybeans 110 into a liquefaction tank, coarse milling the mixture 205 followed by fine milling the mixture 210. Optionally, the process may include a pH adjustment step 215 by adding pH adjusting agents into the liquefaction tank during the coarse milling step 205. The step of liquefying whole soybeans 200 may further comprise cooling down the intermediate product resulted from the fine milling 210 and further homogenize the intermediate product 230 thereby forming the liquefaction product. Treating the liquefaction product with an enzyme 300 may comprise adding the liquefaction product to a heated enzyme treatment tank 320, adding an enzyme to the enzyme treatment tank 315. Optionally, the enzyme treatment step 300 may comprise a pH adjustment 350 step before, during, or after the enzyme addition step 315. The enzyme treatment step 300 may comprise an enzyme deactivation step 330 upon completion, for example, when a desired viscosity or texture is achieved. The present process may further comprise cooling down the enzyme treated product 340 and transferring the whole soy food product (or a whole soy base) to a storage tank 370. The present process may further comprise adjusting pH of the whole soy base 370.

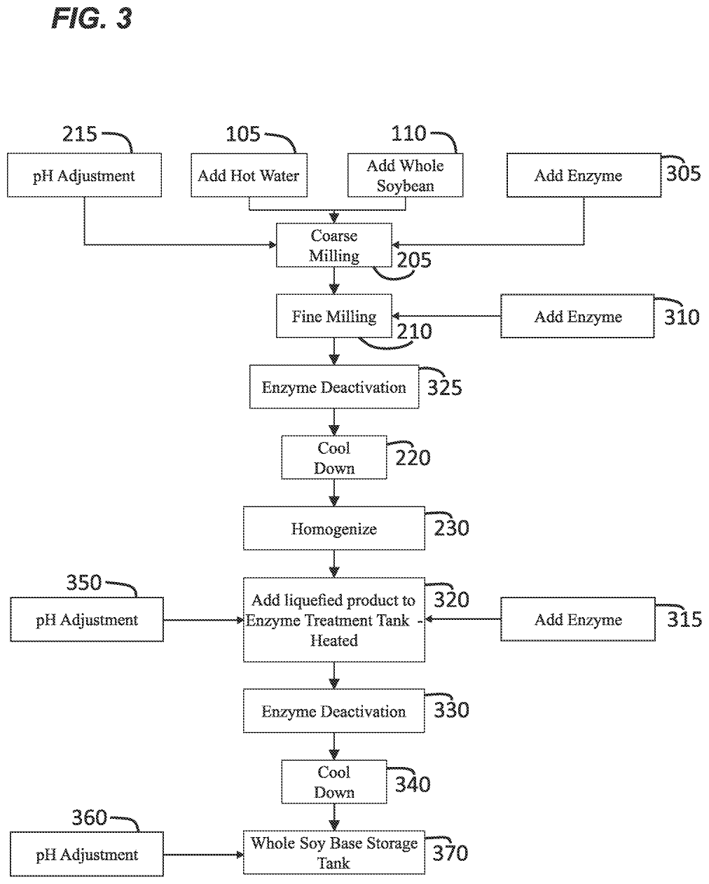

FIG. 3 shows a block diagram of another specific embodiment of a process according to the present disclosure. The process may allow simultaneously liquefying whole soybeans and treating the liquefaction product with an enzyme, and/or multiple steps of enzyme treatment in the process. As shown in FIG. 3, the process comprises forming a mixture by adding hot water 105 and adding whole soybeans 110 into a liquefaction tank, and coarse milling the mixture 205 followed by fine milling the mixture 210. Optionally, the process may include a pH adjustment step 215 by adding pH adjusting agents into the liquefaction tank during the coarse milling step 205. The step of liquefying whole soybeans 200 may further comprise cooling down the intermediate product resulted from the fine milling 210 and further homogenizing the intermediate product 230. The process comprises either adding an enzyme into the liquefaction tank during the coarse milling 305 or adding an enzyme into the liquefaction tank during the fine milling 310, or both. The process may comprise an enzyme deactivation step 325 following completion of enzyme treatment. The process may further comprise cooling down the intermediate product resulted from the fine milling 210 and further homogenize the intermediate product 230 thereby forming the liquefaction product. The liquefaction product may be subject to a further enzyme treatment step. The process may further comprise adding the liquefaction product to a heated enzyme treatment tank 320, adding an enzyme to the enzyme treatment tank 315. Optionally, the enzyme treatment step 300 may comprise a pH adjustment 350 step before, during, or after the enzyme addition step 315. The enzyme treatment step 300 may comprise an enzyme deactivation step 330 upon completion, for example, when a desired viscosity or texture is achieved. The present process may further comprise cooling down the enzyme treated product 340 and transferring the whole soy food product (or a whole soy base) to a storage tank 370. The present process may further comprise adjusting pH of the whole soy base 360.

### Liquefaction

The present process involves liquefaction of raw soybean materials. The soybean material of used herein can be obtained from a variety of soy sources known to those skilled in the art: including, without limitation, whole ground soybeans, soy concentrate, full fat soy meal or grits, whole soybean powder, soybean flakes or powders, fully or partially defatted soybean flakes or powder. As mentioned above, however, considerable cost savings can be realized by eliminating the need to dispose of or otherwise address okara. Accordingly, the full benefit of the present process can be realized by utilizing “whole” soybeans-all or substantially all of the proteinaceous and/or cellulosic components of the soybean material-regardless of the initial soybean material employed. Liquefaction herein refers to one or more steps to liquefy whole soybeans to generate a liquefaction product as an intermediate product. The liquefaction product generally comprises a liquid phase and a non-liquid phase. The non-liquid phase includes soy pulp, soy particulates, and other insoluble parts of the soybeans from liquefaction.

In some embodiments, the present process comprises combining hot water and whole soybeans in a liquefaction tank. The whole soybeans may be soaked in hot water for an appropriate time prior to liquefaction. A person with ordinary skill in the art would be able to determine the weight ratio of water to soybeans to achieve a desired solid content (weight %) of the liquefaction product.

In some embodiments, liquefying whole soybeans of the present process comprises a particle size reduction step wherein the size of the particles in the non-liquid phase is reduced. The size reduction step may comprise a mechanical size reduction step. The mechanical size reduction step may include any technique common in the art of food preparation, such as but not limited to grinding, knife grinding, plate grinding, milling, coarse milling, fine milling, colloidal milling, shearing, threshing, blending, or combinations thereof. The mechanical size reduction step may be carried out by standard food production facilities or equipment, for example, commercially available size reduction machinery supplied by Urschel.

In some embodiments, the size reduction step involves multiple sequential stages: a pre-grinding stage, a colloidal milling stage, a knife grinding stage, and a plate grinding stage to gradually reduce the size of the soy particulates and to precisely control the size distribution thereof. In particular examples as shown in FIGS. 2 and 3, the size reduction step involves subsequent coarse milling 205 followed by fine milling 210.

In some embodiments, the mechanical size reduction step is performed at elevated temperature and/or under pressured conditions. A person skilled in the art will appreciate the principles and operational parameters of the size reduction machinery in order to achieve the liquefaction product described in the present disclosure.

The size reduction step may optionally further comprise a chemical treatment step. In some embodiment the present process comprises a chemical treatment step followed by a mechanical size reduction step. In other embodiments, the present process comprises a chemical treatment during the size reduction step.

In some embodiments, the chemical treatment is pH adjustment 215, 350, or 360 as shown in FIGS. 2 and 3. The pH of the intermediate product during liquefaction may be adjusted, by the addition of food grade acids, or bases, pH buffers, or other pH adjusting agents known in the art. Some suitable acids include but are not limited to, phosphoric acid, citric acid, malic acid, tartaric acid, ascorbic acid, and the like. Some suitable bases include but are not limited to sodium bicarbonate, potassium bicarbonate, and the like. The pH adjusting agents may be added either before or during or after liquefaction.

In some embodiments, the present process may comprise cooling down the intermediate products 220 and 340, as shown in FIGS. 2 and 3. The present process may also comprise homogenizing the liquefaction product 230 after the size reduction step is completed, as shown in FIGS. 2 and 3. Various commercially-available one- or multi-stage homogenizers at different pressure levels can be used in the homogenization step.

In some embodiments, the weight ratio of the liquid fraction to the soy pulp fraction of the liquefaction product is in a range from about 99:1 to about 1:99, or from about 90:10 to about 10:90, or from about 80:20 to about 20:80, or from about 70:30 to about 30:70, or from about 60:40 to about 40:60. In some embodiments, the liquefaction product the liquefaction product comprises all or a substantial portion of the non-liquid phase including the soy particulates, soy pulp, and other insoluble parts of the soybean. In some embodiments, all non-liquid phase is remained in the liquefaction product while no substantial portion of the soy pulp, soy particulates, or insoluble parts of soybeans is removed or discarded.

In some embodiments, the soy particulates in the non-liquid phase is preferably reduced to less than about 200 micrometers in size. More preferably, the soy particulates in the non-liquid phase is reduced to less than 150 micrometers in size. More preferably, the soy particulates in the non-liquid phase is reduced to less than 100 micrometers size. Still more preferably, the soy particulates in the non-liquid phase is reduced to less than 90 micrometers in size. Still more preferably, the soy particulates in the non-liquid phase is reduced to less than 80 micrometers in size. In embodiments, the liquefaction product of the present process has an average particle size in a range from about 30 micrometers to about 100 micrometers, or from about 40 micrometers to about 90 micrometers, or from about 50 micrometers to about 80 micrometers, or from about 60 micrometers to about 70 micrometers.

In some embodiments, the liquefaction product of the present process has a viscosity from about 100 centipoises to about 500 centipoises, or from about 150 centipoises to about 400 centipoises, or from about 200 centipoises to about 400 centipoises, or from about 250 centipoises to about 300 centipoises. In embodiments, the liquefaction product of the present process has a fiber content from about 0.5 wt % to about 5 wt %, or from about 0.7 wt % to about 4 wt %, or from about 0.9 wt % to about 3 wt %, or from about 0.9 wt % to about 2 wt %, or from about 0.9 wt % to about 1.3 wt %.

In embodiments, the liquefaction product of the present process has a solid content from about 5 wt % to about 50 wt %, or from about 10 wt % to about 40 wt %, or from about 15 wt % to about 30 wt %, or from about 20 wt % to about 25 wt %. A skilled person in the art is capable of optimizing the parameters of liquefaction such as the weight ratio of soybean to water to arrive at the desired solid content.

In some embodiments, the process further comprises an optional food preservation step. This food preservation step may include any technique common in the art of food preparation, such as but not limited to pasteurization, thermization, sterilization, UHT, including retort sterilization, high pressure processing (HPP), canning and other methods. This optional step is advantageous as it allows for product with a longer shelf life. A further advantage of a food preservation step which involves heat is an increase in concentration of Maillard reaction products. Such products are the consequence of a reaction between components of the liquefaction product including sugars and amino acids of proteins. The Maillard products often have favorable aromas and tastes which may contribute to a more appealing flavor profile of the soy food product.

In some embodiments, the process is free from introduction of food additives such as preservatives, food coloring agent, viscosity regulator, and artificial flavor to the liquefaction product.

### Enzyme Treatment

Common use of enzymes in the food industry includes ingredient production and texture modification. Many food enzymes are used to degrade various biopolymers. Their specificity and high reaction rates under mild reaction conditions means they are often preferable to chemical treatments. Industrial food enzymes fall into three main groups: hydrolases, oxidoreductases, and isomerases. Bulk degradative enzymes such as proteases, amylase, glucoamylase, pectinases, cellulases (all hydrolases), and hemi-cellulose have been produced using mainly two microbial genera: Bacillus and Aspergillus.

In some embodiments, the process of the present disclosure comprises treating the whole soybeans or any liquefaction products thereof with at least one enzyme. In some embodiments, the process involves treating the whole soybeans or any liquefaction products thereof with at least two enzymes simultaneously or sequentially. The procedures and facilities of enzyme treatment and optimization of operational parameters are generally known to a skilled person in the field of food industry.

In preferred embodiments, the enzyme used in the present process includes alpha-amylase such as BAN® 480 KNU-B/g (Novozyme, Ames, Iowa), which randomly cleaves alpha-1,4 glycosidic bonds. In preferred embodiments, the enzyme used in the present process includes gluco-amylase or amyloglucosidase such as AMG® 300 AGU/mL (Novozyme, Ames, Iowa) which removes glucose units from starch in a stepwise manner. In other embodiments, the enzyme used in the present process includes alpha-amylase such as Termamyl® 120 KNU-T/g (Novozyme, Ames, Iowa). In some embodiments the enzyme is present in a concentration, such as weight percentage of enzyme used during the process, of about 0.05 wt % to about 2.0 wt %, from about 0.15 wt % to about 1.5 wt %, from about 0.2 wt % to about 1.0 wt %, from about 0.35 wt % to about 0.5 wt %, and from about 0.15 wt % to about 0.35 wt %.

In one exemplary example, a liquefaction product of soybean was obtained by liquefying whole soybeans. The resultant soy liquefaction product has a viscosity of about 275 viscosity and an average particle size of about 75 micrometers. The liquefaction product was subsequently treated with alpha-amylase without removing the soy pulp therefrom. It was surprisingly found that alpha-amylase could effectively degrade the soy particulate of the liquefaction product and significantly reduce the viscosity to about less than 60 centipoises, thereby reducing the viscosity by at least 78%.

In some embodiments, the more than one enzyme is used in the present process. In some embodiments both alpha-amylase and gluco-amylase are used. Gluco-amylase is known to be distinct from alpha-amylase because it functions to digest polysaccharides by removing a glucose molecule from the end of polysaccharide by cleaving the terminal alpha-1,4 glycosidic bonds as well as the branching alpha-1,6 glycosidic bond to produce glucose rather than cleaving longer strings of glucose molecules in the middle, forming smaller chains. Combination of alpha-amylase and gluco-amylase in enzyme treatment may improve the efficiency and further reduce the viscosity or the particle size of the liquefaction product. It is noted that gluco-amylase may advantageously produce single or bimolecular sugars that may effectively provide sugar sources for a sweetened soy food product. In some embodiments, the liquefaction and enzyme treatment may be performed simultaneously or in a coordinated fashion. For example, the enzyme could be added in one time, or continuously, or in portions to whole soybeans before or during liquefaction, thereby improving the efficiency of the whole process. The enzyme treatment may be performed under agitation at a mild temperature. In some embodiments the enzyme treatment may be performed for a predetermined period of time. For instance, in some embodiments the enzyme treatment may be about 5 minutes, about 8 minutes, about 10 minutes, about 15 minutes, about 20 minutes, about 30 minutes, about 45 minutes, or about 60 minutes. In some embodiments the enzyme treatment may be greater than 60 minutes. After a desired viscosity or other features are arrived, the enzyme can generally be de-activated by elevating temperature, forming a whole soy food product (or a whole soy base).

For example, the enzyme treatment can be performed after liquefaction as shown in FIG. 2. The liquefaction product is added to a heated enzyme treatment tank 320, and an enzyme is added 315 into the tank. Upon completion of enzyme treatment, for example, upon indication of achieving a desired viscosity or texture or other characteristics, an enzyme deactivation step 330 is performed.

Alternatively, the enzyme treatment can be performed simultaneously with liquefaction (size reduction step), as shown in FIG. 3. An enzyme may be added into the liquefaction tank containing hot water and whole soybeans during the coarse milling 205, or during the fine milling 210, or both. The enzyme added in step 305 and 310 may comprise the same or different enzymes according to the present disclosure.

Alternatively, the present process may include multiple enzyme treatment steps during and after liquefaction as shown in FIG. 3. An enzyme may be added into the liquefaction tank during liquefying whole soybeans (305, 310, or both). After the liquefaction is completed and the liquefaction product is added to the enzyme treatment tank, another enzyme treatment step may be performed by adding an enzyme 315 to the enzyme treatment tank. The enzyme added in step 305, 310, and 315 may comprise the same or different enzymes according to the present disclosure.

Upon completion, the enzyme can be deactivated, and the treatment tank can be cooled down. A whole soy food product (or a whole soy base) is thereby formed and may be transferred to a storage tank. An optional pH adjustment step may be performed to adjust the pH of the whole soy food product to a desired level.

In some embodiments, the enzyme treatment of the present process reduces the viscosity of the liquefaction product by at least 20%, or at least 30%, or at least 40%, or at least 50%, or at least 60%, or at least 70%, or at least 80%, or at least 90%, or at least 95%, or at least 99%.

In embodiments, the whole soy food product (or whole soy base) made by the present process has an average particle size from about 30 micrometers to about 100 micrometers, or from about 40 micrometers to about 90 micrometers, or from about 50 micrometers to about 80 micrometers, or from about 60 micrometers to about 70 micrometers.

In embodiments, the whole soy base made by the present process has a Brix value from about 5° to about 25°, or from about 6° to about 22°, or from about 7° to about 20°, or from about 8° to about 18°, or from about 8° to about 16°, or from about 100 to about 14°, from about 110 to about 13°. In embodiments, the whole soy base made by the present process has a solid content from about 5 wt % to about 30 wt %, or from about 10 wt % to about 25 wt %, or from about 10 wt % to about 20 wt %, or from about 10 wt % to about 15 wt %.

In some embodiments, the whole soy base made from the process has a Brix value of no more than 30°. In some preferred embodiments, the emulsified beverage has a Brix value of no more than 29°, or no more than 28°, or no more than 27°, or no more than 26°, or no more than 25°, or no more than 24°, or no more than 23°, or no more than 22°, or no more than 21°, or no more than 20°, or no more than 19°, no more than 18°, or no more than 170, or no more than 16°, or no more than 15°, or no more than 14°, or no more than 13°, or no more than 12°, or no more than 11°, or no more than 10°, or no more than 9°, or no more than 8°, or no more than 7°, or no more than 6°, or no more than 5°, or no more than 4°, or no more than 3°, or no more than 2°, or no more than 1°. Preferably, the whole soy base made from the process or the final soy beverage has a Brix value from about 5° to about 25°, or from about 6° to about 22°, or from about 7° to about 20°, or from about 8° to about 18°, or from about 8° to about 16°, or from about 100 to about 14°, from about 11° to about 13°.

In some embodiments, the whole soy base made from the process has an average particle size of no more than 30 micrometers, or no more than 29 micrometers, or no more than 28 micrometers, or no more than 27 micrometers, or no more than 26 micrometers, or no more than 25 micrometers, or no more than 24 micrometers, or no more than 23 micrometers, or no more than 22 micrometers, or no more than 21 micrometers, or no more than 20 micrometers, or no more than 19 micrometers, or no more than 18 micrometers, or no more than 17 micrometers, or no more than 16 micrometers, or no more than 15 micrometers, or no more than 14 micrometers, or no more than 13 micrometers, or no more than 12 micrometers, or no more than 11 micrometers, or no more than 10 micrometers, or no more than 9 micrometers, or no more than 8 micrometers, or no more than 7 micrometers, or no more than 6 micrometers, or no more than 5 micrometers, or no more than 4 micrometers, or no more than 3 micrometers, or no more than 2 micrometers, or no more than 1 micrometer.

In some embodiments, the whole soy base made from the process has a protein content in a range from about 1 wt % to about 10 wt %, or from about 2 wt % to about 9 wt %, from about 3 wt % to about 8 wt %, from about 4 wt % to about 7 wt %, or from about 5 wt % to about 6 wt %.

In some embodiments, the whole soy base made from the process has a total solid content of less than 30 wt %. In some preferred embodiments, the whole soy base made from the process or the final soy beverage has a total solid content of no more than 30 wt %, or no more than 29 wt %, or no more than 28 wt %, or no more than 27 wt %, or no more than 26 wt %, or no more than 25 wt %, or no more than 24 wt %, or no more than 23 wt %, or no more than 22 wt %, or no more than 21 wt %, or no more than 20 wt %, or no more than 19 wt %, or no more than 18 wt %, or no more than 17 wt %, or no more than 16 wt %, or no more than 15 wt %, or no more than 14 wt %, or no more than 13 wt %, or no more than 12 wt %, or no more than 11 wt %, or no more than 10 wt %, or no more than 9 wt %, or no more than 8 wt %, or no more than 7 wt %, or no more than 6 wt %, or no more than 5 wt %, or no more than 4 wt %, or no more than 3 wt %, or no more than 2 wt %, or no more than 1 wt %. Preferably, the whole soy base made from the process or the final soy beverage has a total solid content from about 5 wt % to about 30 wt %, or from about 10 wt % to about 25 wt %, or from about 10 wt % to about 20 wt %, or from about 10 wt % to about 15 wt %.

It was surprisingly found that the whole soy based made by the present process is stable for a long period of time without significant fat separation, layer separation, precipitation, sedimentation, or coagulation. As an example, a whole soy base made by the present process has a solid content of about 12% a viscosity of about 58% was found to be suitable for human consumption for at least 12 months under common storage condition. In embodiments, the whole soy base does not show obvious separation of fat, sedimentation, precipitation, or coagulation for at least 12 months.

### Whole Soy Foodstuffs and Beverages

The present process produces a whole soy food product (or a whole soy base), which can by itself serve as a final soy product or beverage for direct consumption. Alternatively, the whole soy base can be used as a component and combined with other ingredients or subjected to further treatment to produce final soy foodstuffs or beverages for consumers.

In some embodiments, a soy foodstuff comprises at least a portion of a whole soy product made by the process according to the present disclosure. In embodiments, the process comprises: liquefying whole soybeans, forming a liquefaction product, wherein the liquefaction product comprises a liquid fraction and a soy pulp fraction; and treating the liquefaction product with an enzyme, thereby forming the whole soy food product (or a whole soy base).

The soy foodstuff may be solid or semi-solid, including but not mot limited to a soy yogurt, tofu, miso, tempeh, soy puree, soy paste, or soy sauce.

In some embodiments, a soy beverage comprises at least a portion of a whole soy product made by the process according to the present disclosure. In embodiments, the process comprises: liquefying whole soybeans, forming a liquefaction product, wherein the liquefaction product comprises a liquid fraction and a soy pulp fraction; and treating the liquefaction product with an enzyme, thereby forming the whole soy food product.

The soy beverage described herein includes but is not limited to soy milk, soy milk fruit beverage, sweetened or unsweetened soy drink, or soy smoothies.

In embodiments, the soy beverage described herein has a viscosity from about 10 centipoises to about 100 centipoises, or from about 20 centipoises to about 80 centipoises, or from about 30 centipoises to about 70 centipoises, or from about 40 centipoises to about 60 centipoises. In embodiments, soy beverage has an average particle size from about 30 micrometers to about 100 micrometers, or from about 40 micrometers to about 90 micrometers, or from about 50 micrometers to about 80 micrometers, or from about 60 micrometers to about 70 micrometers. In embodiments, the soy beverage has a Brix value from about 5° to about 25°, or from about 6° to about 22°, or from about 7° to about 20°, or from about 8° to about 18°, or from about 8° to about 16°, or from about 100 to about 14°, from about 11° to about 13°. In embodiments, the soy beverage has a solid content from about 5 wt % to about 30 wt %, or from about 10 wt % to about 25 wt %, or from about 10 wt % to about 20 wt %, or from about 10 wt % to about 15 wt %.

The foodstuffs and beverages of the present disclosure are preferably dairy free, animal free, alcohol free, and in some embodiments, gluten-free. These are all advantages as these are qualities that consumers appreciate in a beverage.

In some embodiments, the final soy beverage has a Brix value of no more than 30°. In some preferred embodiments, the emulsified beverage has a Brix value of no more than 29°, or no more than 28°, or no more than 27°, or no more than 26°, or no more than 25°, or no more than 24°, or no more than 23°, or no more than 22°, or no more than 21°, or no more than 20°, or no more than 19°, no more than 18°, or no more than 17°, or no more than 16°, or no more than 15°, or no more than 14°, or no more than 13°, or no more than 12°, or no more than 11°, or no more than 10°, or no more than 9°, or no more than 8°, or no more than 7°, or no more than 6°, or no more than 5°, or no more than 4°, or no more than 3°, or no more than 2°, or no more than 1°. Preferably, the whole soy base made from the process or the final soy beverage has a Brix value from about 5° to about 25°, or from about 6° to about 22°, or from about 7° to about 20°, or from about 8° to about 18°, or from about 8° to about 16°, or from about 100 to about 14°, from about 11° to about 13°.

In some embodiments, the final soy beverage has an average particle size of no more than 30 micrometers, or no more than 29 micrometers, or no more than 28 micrometers, or no more than 27 micrometers, or no more than 26 micrometers, or no more than 25 micrometers, or no more than 24 micrometers, or no more than 23 micrometers, or no more than 22 micrometers, or no more than 21 micrometers, or no more than 20 micrometers, or no more than 19 micrometers, or no more than 18 micrometers, or no more than 17 micrometers, or no more than 16 micrometers, or no more than 15 micrometers, or no more than 14 micrometers, or no more than 13 micrometers, or no more than 12 micrometers, or no more than 11 micrometers, or no more than 10 micrometers, or no more than 9 micrometers, or no more than 8 micrometers, or no more than 7 micrometers, or no more than 6 micrometers, or no more than 5 micrometers, or no more than 4 micrometers, or no more than 3 micrometers, or no more than 2 micrometers, or no more than 1 micrometer.

In some embodiments, the final soy beverage has a protein content in a range from about 1 wt % to about 10 wt %, or from about 2 wt % to about 9 wt %, from about 3 wt % to about 8 wt %, from about 4 wt % to about 7 wt %, or from about 5 wt % to about 6 wt %.

In some embodiments, the final soy beverage has a total solid content of less than 30 wt %. In some preferred embodiments, the whole soy base made from the process or the final soy beverage has a total solid content of no more than 30 wt %, or no more than 29 wt %, or no more than 28 wt %, or no more than 27 wt %, or no more than 26 wt %, or no more than 25 wt %, or no more than 24 wt %, or no more than 23 wt %, or no more than 22 wt %, or no more than 21 wt %, or no more than 20 wt %, or no more than 19 wt %, or no more than 18 wt %, or no more than 17 wt %, or no more than 16 wt %, or no more than 15 wt %, or no more than 14 wt %, or no more than 13 wt %, or no more than 12 wt %, or no more than 11 wt %, or no more than 10 wt %, or no more than 9 wt %, or no more than 8 wt %, or no more than 7 wt %, or no more than 6 wt %, or no more than 5 wt %, or no more than 4 wt %, or no more than 3 wt %, or no more than 2 wt %, or no more than 1 wt %. Preferably, the whole soy base made from the process or the final soy beverage has a total solid content from about 5 wt % to about 30 wt %, or from about 10 wt % to about 25 wt %, or from about 10 wt % to about 20 wt %, or from about 10 wt % to about 15 wt %.

### Examples

Trial 1

The impact of enzyme treatment on whole soy base (liquefaction) on viscosity and sugar formation was determined. In Trial 1 samples of Argentinian (TetraPak) Soy Base were treated with the either BAN® 480L ((Novozyme, Ames, Iowa) or AMG® 300L (Novozyme, Ames, Iowa) or a combination of these enzymes according to Table 1, for 90 minutes at 65° C.

TABLE 1

| | Argentinian | | |
|---|---|---|---|
| | Soy Base | BAN ® | AMG ® |
| Sample | (TASAg) gm | 480 L (gm) | 300 L (gm) |
| Control | 100 | — | — |
| Sample 1 | 99.8 | 0.2 | — |
| Sample 2 | 99.85 | 0.1 | 0.05 |
| Sample 3 | 99.75 | 0.2 | 0.5 |
| Sample 4 | 99.65 | 0.3 | 0.05 |

After enzyme treatment the samples were immediately cooled to below 10° C. using a cold-water bath or by storing the sample in a freezer for not more than 5 minutes. After cooling it was observed that the enzyme treated samples had a thick dry skin layer caused by congealing of the Soy base. The samples were subsequently reheated to 80° C. using a water bath. Samples 2-4 were observed to be more viscous than the control Soy base, however, this viscosity testing is not possible due to the semi solid state of the samples.

The sugar composition of the samples was measured by HPLC and is provided in Table 2 below.

TABLE 2

| Sample | % Glucose | % Sucrose | % Maltose | % Raffinose | % Stachyose |
|---|---|---|---|---|---|
| Control | <0.05 | 1.3 | <0.05 | <0.05 | <0.05 |
| Sam- | <0.05 | 1.5 | <0.05 | 0.1 | 0.6 |
| ple 1 | | | | | |
| Sam- | <0.05 | 1.7 | <0.05 | 0.1 | 0.7 |
| ple 2 | | | | | |
| Sam- | <0.05 | 1.4 | <0.05 | 0.1 | 0.6 |
| ple 3 | | | | | |
| Sam- | <0.05 | 1.3 | <0.05 | 0.1 | 0.6 |
| ple 4 | | | | | |

Trial 2

A second trial (Trial 2) was conducted to determine the impact of enzyme treatment on whole soy base (liquefaction) on viscosity and sugar formation. Samples of Soy Base (500 g) were treated with the either BAN® 480L ((Novozyme, Ames, Iowa) or AMG® 300L (Novozyme, Ames, Iowa) or a combination of these enzymes according to Table 3 at 65° C. for the treatment times indicated.

TABLE 3

| | Argentinian | | | |
|---|---|---|---|---|
| | Soy Base | BAN ® | AMG ® | Treat- |
| | (TASAg) gm | 480 L | 300 L | ment |
| | at 4% protein | (gm) | (gm) | Time |
| Control | 130 g | — | — | — |
| Sample 5 | 498 | 2 | — | 30 min |
| | | (0.4% BAN ®) | | |
| Sample 6 | 498 | 2 | — | 45 min |
| Sample 6 | 498 | 2 | — | 60 min |
| Sample 7 | 497 | 1.75 | 1 | 30 min |
| | | (0.35% BAN ®) | | |
| Sample 8 | 497 | 1.75 | 1 | 45 min |
| Sample 9 | 497 | 1.75 | 1 | 60 min |
| Sample 10 | 497 | 2 | 1 | 30 min |
| | | (0.4% BAN ®) | | |
| Sample 11 | 497 | 2 | 1 | 45 min |
| Sample 12 | 497 | 2 | 1 | 60 min |
| Sample 13 | 497 | 2.25 | 1 | 30 min |
| | | (0.45% BAN ®) | | |
| Sample 14 | 497 | 2.25 | 1 | 45 min |
| Sample 15 | 497 | 2.25 | 1 | 60 min |
| Sample 16 | 497 | 2.5 | 1 | 30 min |
| | | (0.5% BAN ®) | | |
| Sample 17 | 497 | 2.5 | 1 | 30 min |
| Sample 18 | 497 | 2.5 | 1 | 45 min |
| Sample 19 | 497 | 2.5 | 1 | 60 min |

After enzyme treatment the samples were immediately cooled to below 10° C. using a cold-water bath or by storing the sample in a freezer for not more than 5 minutes. Compared to the Trial 1, Samples 5-19 of Trial 2 all produced thinner, less viscous products, with the absence of skin formation. No thickening was observed after cooling.

The sugar composition of the samples was measured by 1-PLC and is provided in Table 4 below.

TABLE 4

| | % Glu- | % Su- | | | |
|---|---|---|---|---|---|
| Sample | cose | crose | % Maltose | % Raffinose | % Stachyose |
| Sample 5 | <0.05 | 0.2 | <0.05 | 0.04 | 0.28 |
| Sample 6 | <0.05 | 0.19 | <0.05 | 0.04 | 0.22 |
| Sample 7 | <0.05 | 0.24 | <0.05 | 0.05 | 0.28 |
| Sample 8 | <0.05 | 0.26 | <0.05 | 0.06 | 0.31 |
| Sample 9 | <0.05 | 0.22 | <0.05 | 0.06 | 0.27 |
| Sample 10 | <0.05 | 0.18 | <0.05 | 0.04 | 0.22 |
| Sample 11 | <0.05 | 0.24 | <0.05 | 0.05 | 0.28 |
| Sample 12 | <0.05 | 0.24 | <0.05 | 0.06 | 0.3 |
| Sample 13 | <0.05 | 0.39 | <0.05 | 0.07 | 0.42 |
| Sample 14 | <0.05 | 0.4 | <0.05 | 0.05 | 0.42 |
| Sample 15 | <0.05 | 0.41 | <0.05 | 0.06 | 0.42 |
| Sample 16 | <0.05 | 0.4 | <0.05 | 0.06 | 0.42 |
| Sample 17 | <0.05 | 0.39 | <0.05 | 0.06 | 0.44 |
| Sample 18 | <0.05 | 0.42 | <0.05 | 0.06 | 0.44 |
| Sample 19 | <0.05 | 0.41 | <0.05 | 0.06 | 0.42 |

Trial 3

A third trial (Trial 3) was conducted to determine the impact of enzyme treatment with BAN® 480L and Termamyl® on Whole Soy-base on viscosity and sugar formation. Samples of Urschel Soy Base (500 g) were treated with the either BAN® 480L ((Novozyme, Ames, Iowa) or Termamyl® (Novozyme, Ames, Iowa) or a combination of these enzymes according to Table 5 at 65° C. for the treatment times indicated.

TABLE 5

| | Urschel | | | |
|---|---|---|---|---|
| | Liquefaction | | | Treat- |
| | Soy Base gm | BAN ® | | ment |
| Sample | at 3.5% Protein | 480 L (gm) | Termamyl ® | Time |
| Control | 500 | — | — | 30/60 min |
| 3.5% protein | | | | |
| Sample 21 | 499 | 1 | — | 60 min |
| Sample 22 | 498.75 | 1.25 | — | 60 min |
| Sample 23 | 498 | — | 2 | 60 min |
| Sample 24 | 497.5 | — | 2.5 | 60 min |

After enzyme treatment the samples were immediately cooled to below 10° C. using a cold-water bath or by storing the sample in a freezer for not more than 5 minutes. Compared to the Trial 1, Samples 21-24 of Trial 3 all produced thinner, less viscous products, with the absence of skin formation. No thickening was observed after cooling.

The viscosity of samples 21-24 were measured using a Brookfield® viscometer and the values are provided in Table 6 below.

TABLE 6

| | Measured | Bath |
|---|---|---|
| | Viscosity | Temperature |
| | (cP) | (° C.) |
| Ades Control | 6.7 | 25 |
| Soymilk | | |
| Soy base Control | 6.9 | 25 |
| Unheated | | |
| Soy base Control | 12.6 | 25 |
| Heated 30 min | | |
| Soy base Control | 11.7 | 25 |
| Heated 60 min | | |
| Sample 21 | 18.3* | 25 |
| Sample 22 | 68.7* | 25 |
| Sample 23 | 174.8* | 25 |
| Sample 24 | 97.9* | 25 |

*Indicates shear-thinning after enzyme treatment

The sugar composition of the samples was measured by HPLC and is provided in Table 7 below.

TABLE 7

| | % Glu- | % Su- | | | |
|---|---|---|---|---|---|
| Sample | cose | crose | % Maltose | % Fructose | % Stachyose |
| Control | <0.1 | 0.500 | <0.05 | <0.1 | 0.371 |
| Sample 21 | <0.1 | 0.601 | <0.05 | <0.1 | 0.361 |
| Sample 22 | <0.1 | 0.626 | <0.05 | <0.1 | 0.366 |
| Sample 23 | <0.1 | 0.538 | <0.05 | <0.1 | 0.369 |
| Sample 24 | <0.1 | 0.513 | <0.05 | <0.1 | 0.371 |

Trial 4

A fourth trial (Trial 4) was conducted to determine the impact of enzyme treatment with BAN® 480L on Urschel Whole Soy-base pre and post grinding. Samples of Urschel Soy Base (500 g) were treated with the either BAN® 480L ((Novozyme, Ames, Iowa) pre and post grinding according to Table 8 at 65° C. for the treatment times indicated.

TABLE 8

| | Urschel | | |
|---|---|---|---|
| | Liquefaction Soy | | Treat- |
| | Base gm at 3.5% | BAN ® 480 L | ment |
| Sample | Protein | (gm) | Time |
| Control (No | 800 g | — | — |
| Heat) | | | |
| Control (Heat) | 800 g | | |
| Sample 25 | | Pre-Grind 0.2% | 0 |
| (BAN ® 0.2% | | | |
| Pre-grind) | | | |
| Sample 26 | 798.4 g | Post-Grind | 30 min |
| (BAN ® 0.2% | | 0.2% (1.6 g) | |
| Post-grind) | | | |
| Sample 27 | 796.8 g | 0.4% (3.2 g) | 30 min |
| (BAN ® 0.4%) | | | |
| Sample 28 | 796 g | 0.5% (4.0 g) | 30 min |
| (BAN ® 0.4%) | | | |

After enzyme treatment the samples were immediately cooled to below 10° C. using a cold-water bath or by storing the sample in a freezer for not more than 5 minutes. Compared to the Trial 1, Samples 25-28 of Trial 4 all produced thinner, less viscous products, with the absence of skin formation. No thickening was observed after cooling.

The viscosity of samples 25-28 were measured and the values are provided in Table 9 below.

TABLE 9

| | Measured | Measured | |
|---|---|---|---|
| | Viscosity (cP) | Viscosity | Bath |
| | Apopka | (cP) | Temper- |
| | Sheer rate | Eurofin | ature |
| | 100 s⁻¹ | 100 RPM | (° C.) |
| Ades Control | 6.7 | — | 25 |
| Soymilk | | | |
| Control (No Heat) | 64.8 | 59.7 | 25 |
| Control (Heat) | 72.2 | 66.2 | 25 |
| Sample 25 (BAN ® | 41.6 | 247.0 | 25 |
| 0.2% Pre-grind) | | | |
| Sample 26 (BAN ® | 95.2 | 128.0 | 25 |
| 0.2% Post-grind) | | | |
| Sample 27 (BAN ® | 131.5 | 143.0 | 25 |
| 0.4%) | | | |
| Sample 28 (BAN ® | 147.0 | 124.0 | 25 |
| 0.4%) | | | |
| Control (No Heat) | 93.9 | 91.8 | 10 |
| Control (Heat) | 107.15 | 101.0 | 10 |
| Sample 25 (BAN ®) | 58.3 | 313.0 | 10 |
| 0.2% Pre-grind) | | | |
| Sample 26 (BAN ® | 137.0 | 197.0 | 10 |
| 0.2% Post-grind) | | | |
| Sample 27 (BAN ® | 177.9 | 186.0 | 10 |
| 0.4%) | | | |
| Sample 28 (BAN ® | 195.3 | 167.0 | 10 |
| 0.4%) | | | |

A few samples showed minor shear-thinning after enzyme treatment. However it appears that the usage of BAN® post-grind tend to increase viscosity after cooling.

The sugar composition of the samples was measured by HPLC and is provided in Table 10 below.

TABLE 10

| | % | | % | | % |
|---|---|---|---|---|---|
| Sample | Glucose | % Sucrose | Maltose | % Fructose | Stachyose |
| Control (No | <0.1 | 1.04 | <0.1 | <0.1 | 0.48 |
| Heat) | | | | | |
| Control | <0.1 | 1.01 | <0.1 | <0.1 | 0.45 |
| (Heat) | | | | | |
| Sample 25 | <0.1 | 0.97 | <0.1 | <0.1 | 0.47 |
| (BAN ® 0.2% | | | | | |
| Pre- | | | | | |
| grind) | | | | | |
| Sample 26 | <0.1 | 1.02 | <0.1 | <0.1 | 0.46 |
| (BAN ® 0.2% | | | | | |
| Post- | | | | | |
| grind) | | | | | |
| Sample 27 | <0.1 | 1.02 | <0.1 | <0.1 | 0.46 |
| (BAN ® | | | | | |
| 0.4%) | | | | | |
| Sample 28 | <0.1 | 1.01 | <0.1 | <0.1 | 0.45 |
| (BAN ® | | | | | |
| 0.4%) | | | | | |

The length of the glucose chains produced was also determined and is provided in Table 11 below.

TABLE 11

| Label | Sample | G1 | G2 | G3 | G4-G10 | >G10 |
|---|---|---|---|---|---|---|
| 1A | Control (No Heat) | 71.9 | 25.3 | 2.6 | 0.3 | 0.0 |
| 2A | Control (Heat) | 71.2 | 25.7 | 2.8 | 0.3 | 0.0 |
| 3A | Sample 25 (BAN ® | 64.7 | 25.1 | 5.7 | 4.2 | 0.4 |
| | 0.2% Pre-grind) | | | | | |
| 4A | Sample 26 (BAN ® | 62.6 | 25.3 | 4.0 | 5.4 | 2.7 |
| | 0.2% Post-grind) | | | | | |
| 5A | Sample 27 (BAN ® | 55.7 | 23.8 | 4.6 | 10.5 | 5.5 |
| | 0.4%) | | | | | |
| 6A | Sample 28 (BAN ® | 61.2 | 24.0 | 3.9 | 7.4 | 3.4 |
| | 0.4%) | | | | | |

The data indicates the BAN® Treatment seems to increase formation of glucose chains 4 and longer.

The protein content of each sample was also determined and is provided in Table 12 below.

TABLE 12

| | % Protein |
|---|---|
| Control (No Heat) | 4.522 |
| Control (Heat) | 4.586 |
| Sample 25 (BAN ® 0.2% Pre-grind) | 4.668 |
| Sample 26 (BAN ® 0.2% Post-grind) | 4.546 |
| Sample 27 (BAN ® 0.4%) | 4.548 |
| Sample 28 (BAN ® 0.4%) | 4.609 |

Finally the moisture content of each sample was determined and is provided in Table 13 below.

TABLE 13

| Sample | Solids % | Moisture % |
|---|---|---|
| Control (No Heat) | 14% | 86% |
| Control (Heat) | 16% | 84% |
| Sample 25 (BAN ® 0.2% | 16% | 84% |
| Pre-grind) | | |
| Sample 26 (BAN ® 0.2% | 19% | 81% |
| Post-grind) | | |
| Sample 27 (BAN ® 0.4%) | 18% | 82% |
| Sample 28 (BAN ® 0.4%) | 18% | 82% |

The above specification, examples and data provide a complete description of the manufacture and use of the composition of the invention. Since many embodiments of the invention can be made without departing from the spirit and scope of the invention, the invention resides in the claims hereinafter appended.

1-39. (canceled)

40. A process of making a whole soy food product comprising:
liquefying whole soybeans, forming a liquefaction product, wherein the liquefaction product comprises a liquid fraction and a soy pulp fraction; and
treating the liquefaction product with an enzyme, thereby forming the whole soy food product.

41. The process of claim 40, wherein the whole soy food product has a viscosity from about 10 centipoises to about 100 centipoises, or from about 20 centipoises to about 80 centipoises, or from about 30 centipoises to about 70 centipoises, or from about 40 centipoises to about 60 centipoises.

42. The process of claim 40, wherein the weight ratio of the liquid fraction to the soy pulp fraction is in a range from about 99:1 to about 1:99, or from about 90:10 to about 10:90, or from about 80:20 to about 20:80, or from about 70:30 to about 30:70, or from about 60:40 to about 40:60.

43. The process of claim 40, wherein the liquefaction product comprises all or a substantial portion of the soy pulp.

44. The process of claim 40, wherein the liquefaction product has an average particle size in a range from about 30 micrometers to about 100 micrometers, or from about 40 micrometers to about 90 micrometers, or from about 50 micrometers to about 80 micrometers, or from about 60 micrometers to about 70 micrometers.

45. The process of claim 40, wherein the liquefaction product has an average viscosity from about 100 centipoises to about 500 centipoises, or from about 150 centipoises to about 400 centipoises, or from about 200 centipoises to about 400 centipoises, or from about 250 centipoises to about 300 centipoises.

46. The process of claim 40, wherein the liquefaction product has an average fiber content from about 0.5 wt % to about 5 wt %, or from about 0.7 wt % to about 4 wt %, or from about 0.9 wt % to about 3 wt %, or from about 0.9 wt % to about 2 wt %, or from about 0.9 wt % to about 1.3 wt %.

47. The process of claim 40, wherein the enzyme is selected from the group consisting of alpha-amylase, fungal alpha-amylase, gluco-amylase, protease, cellulase, or combinations thereof.

48. The process of claim 40, wherein the enzyme reduces the viscosity of the liquefaction product by at least 20%, or at least 30%, or at least 40%, or at least 50%, or at least 60%, or at least 70%, or at least 80%, or at least 90%.

49. The process of claim 40, wherein the whole soy food product has a Brix value from about 5° to about 25°, or from about 6° to about 22° or from about 7° to about 20°, or from about 8° to about 180, or from about 8° to about 16°, or from about 10° to about 14°, from about 11° to about 13°.

50. The process of claim 40, wherein the whole soy food product has a solid content from about 5 wt % to about 30 wt %, or from about 10 wt % to about 25 wt %, or from about 10 wt % to about 20 wt %, or from about 10 wt % to about 15 wt %.

51. A foodstuff comprising at least a portion of a whole soy product made by a process, the process comprising:
liquefying whole soybeans, forming a liquefaction product, wherein the liquefaction product comprises a liquid fraction and a soy pulp fraction; and
treating the liquefaction product with an enzyme, thereby forming the whole soy food product.

52. The foodstuff of claim 51, wherein the whole soy food product has a viscosity from about 10 centipoises to about 100 centipoises, or from about 20 centipoises to about 80 centipoises, or from about 30 centipoises to about 70 centipoises, or from about 40 centipoises to about 60 centipoises.

53. The foodstuff of claim 51, wherein the weight ratio of the liquid fraction to the soy pulp fraction is in a range from about 99:1 to about 1:99, or from about 90:10 to about 10:90, or from about 80:20 to about 20:80, or from about 70:30 to about 30:70, or from about 60:40 to about 40:60.

54. The foodstuff of claim 51, wherein the liquefaction product comprises all or a substantial portion of the soy pulp.

55. The foodstuff of claim 51, wherein the liquefaction product has an average viscosity from about 100 centipoises to about 500 centipoises, or from about 150 centipoises to about 400 centipoises, or from about 200 centipoises to about 400 centipoises, or from about 250 centipoises to about 300 centipoises.

56. The foodstuff of claim 51, wherein the liquefaction product has a solid content from about 5 wt % to about 50 wt %, or from about 10 wt % to about 40 wt %, or from about 15 wt % to about 30 wt %, or from about 20 wt % to about 25 wt %.

57. The foodstuff of claim 51, wherein liquefying whole soybeans is performed using a method selected from the group consisting of grinding, milling, colloidal milling, knife grinding, urschel grinding, or combinations thereof.

58. The foodstuff of claim 51, wherein the enzyme reduces the viscosity of the liquefaction product by at least 20%, or at least 30%, or at least 40%, or at least 50%, or at least 60%, or at least 70%, or at least 80%, or at least 90%.

59. A soy beverage comprising at least a portion of a whole soy product made by a process, the process comprising:
liquefying whole soybeans, forming a liquefaction product, wherein the liquefaction product comprises a liquid fraction and a soy pulp fraction, and wherein the liquefaction product comprises all or a substantial portion of the soy pulp;
treating the liquefaction product with an enzyme, thereby forming the whole soy food product;
wherein the weight ratio of the liquid fraction to the soy pulp fraction is in a range from about 99:1 to about 1:99; and
wherein the soy beverage has a solid content from about 5 wt % to about 30 wt %.

60.
